(19) United States
(12) Patent Application Publication
(10) Pub. No.: US 2005/0188191 A1
(43) Pub. Date: Aug. 25, 2005

(54) Resource discovery method and cluster manager apparatus

(75) Inventors: Hideki Yoshida, Tokyo (JP); Nobuo Sakiyama, Kanagawa-ken (JP); Tatsunori Kanai, Kanagawa-ken (JP); Toshio Shirakihara, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA.

(21) Appl. No.: 10/995,172

(22) Filed: Nov. 24, 2004

(30) Foreign Application Priority Data
Feb. 20, 2004 (JP) P2004-043983

(51) Int. Cl. G06F 9/00

(52) U.S. Cl. 713/1

(57) ABSTRACT

A computer system includes a plurality of clusters each having at least one resource. At least one cluster has a resource matched with static resource information of a cluster discovery request. The at least one cluster is selected by referring to static resource information of resources in each cluster of a discovery object. The at least one cluster is a candidate cluster. A resource matched with dynamic resource information of a resource discovery request is searched from the candidate cluster by referring to dynamic resource information of resources in the candidate cluster.

### CROSS-REFERENCE TO RELATED APPLICATIONS

This application is based upon and claims the benefit of priority from prior Japanese Patent Application P2004-043983, filed on Feb. 20, 2004; the entire contents of which are incorporated herein by reference.

### FIELD OF THE INVENTION

The present invention relates to a resource discovery method and a cluster manager apparatus for executing accommodation of resources in a cluster system.

### BACKGROUND OF THE INVENTION

A cluster system collectively manages resources of a computer or a disk, and assigns a resource to an application in response to necessity. By using the cluster system, reliability, processing ability, and a use ratio of resources improve. The cluster system can be realized as a form managing resources by operating a cluster manager as one module of middleware or OS on one or a plurality of computers of a cluster.

A regular cluster system assigns resources within one cluster only. However, recently, in the case that the resources in one cluster are not enough because of data increase of processing object or request of cost reduction, resource accommodation among multiple clusters is desired in order to cope with resource shortage.

In general, a predetermined CPU or OS is requested to operate an application. Resources in a computer not satisfying this request can not be utilized. Accordingly, in the case of accommodation of resources among multiple clusters, a mechanism to discover usable resources among multiple clusters is necessary. In the case of discovery, information (resource information) related to a resource such as a kind of CPU or OS requested by the application is indicated as a condition. (Hereinafter, “discover” and “discovery” mean “search”.)

This condition includes a discrete condition and a continuous condition. The discrete condition represents a condition such as a kind of CPU, where the condition is either satisfied or not. The continuous condition represents a condition such as a clock speed of a CPU, where a value as large as possible is preferred on the basis that a minimum condition is satisfied. These information are called a static resource information previously describable as a configuration file.

On the other hand, information such as network proximity of a resource to the cluster changes depending on which cluster borrows resources, and information such as present load of a CPU changes with the passage of time. This dynamic resource information is measured at the time of resource discovery.

As for a resource discovery method in a single cluster of the prior art, a desired condition is finely indicated, and a resource matched with the condition is discovered (retrieved) from all resources. As for resource accommodation which is examined at the present among multiple clusters, the above-mentioned resource discovery method for a single cluster is applied for multiple clusters. Concretely, a cluster wishing to borrow a resource finely indicates a condition of the resource, and the resource matched with the condition is discovered from resources of all clusters.

However, in this method, information of resources matched with the condition is sent and received among all clusters. As a result, communication quantity and processing quantity among multiple clusters largely increase. Especially, in the case of discovering a resource using a condition as the dynamic resource information, it is necessary to measure the dynamic resource information at the time of resource discovery. If such measurement is executed each time a resource is discovered, cost of the measurement becomes high. Accordingly, it is necessary to accommodate resources under the condition of static resource information previously describable or under the condition of dynamic resource information at a high cost.

On the other hand, as a method to discover a suitable resource using the dynamic resource information, use situation of each cluster and network resource is normalized based on time and parameterized, and a cluster apparatus to distribute an application job is dynamically set based on the parameter value (For example, Japanese Patent Disclosure (Kokai) 2002-259353 (pages 4-6, FIG. 2, FIG. 8).

However, in this method, by utilizing dynamic resource information only, a cluster manager apparatus of a cluster to borrow resources decides another cluster to which an application job is diverted. Accordingly, update of use situation of dynamic resource information and network resource of other clusters is necessary. Such information update is periodically executed in the manager apparatus of each cluster. As a result, communication quantity and processing quantity become large.

### SUMMARY OF THE INVENTION

The present invention is directed to a resource discovery method and a cluster manager apparatus able to reduce communication quantity and processing quantity of resource search to accommodate resources among multiple clusters.

According to an aspect of the present invention, there is provided a resource discovery method in a computer system including a plurality of clusters each having at least one resource, comprising: searching at least one cluster having a resource matched with static resource information of a cluster discovery request by referring to static resource information of resources in each cluster of a discovery object, the at least one cluster being a candidate cluster; and searching a resource matched with dynamic resource information of a resource discovery request from the candidate cluster by referring to dynamic resource information of resources in the candidate cluster.

According to another aspect of the present invention, there is also provided a cluster manager apparatus, each cluster having at least one resource in a computer system, comprising: an issue unit configured to issue a cluster discovery request, including static resource information, to a plurality of clusters of a discovery object; and a receiving unit configured to receive cluster information matched with the static resource information, the cluster information representing at least one candidate cluster in the plurality of clusters; wherein said issue unit issues a resource discovery request including dynamic resource information to the at least one candidate cluster; and wherein said receiving unit receives resource information matched with the dynamic resource information from the at least one candidate cluster.

According to still another aspect of the present invention, there is also provided a cluster manager apparatus, each cluster having at least one resource in a computer system, comprising: a static resource information memory configured to store static resource information of resources in a cluster; a dynamic resource information measurement unit configured to measure dynamic resource information of the resources in the cluster; a search unit configured to search a resource matched with static resource information of a cluster discovery request by referring to said static resource information memory in response to the cluster discovery request sent by a request source cluster; and a sending unit configured to send cluster information of the cluster to the request source cluster when the resource matched with the static resource information is searched; wherein said search unit searches a resource matched with dynamic resource information of a resource discovery request by referring to said dynamic resource information measurement unit in response to the resource discovery request sent by the request source cluster, and wherein said sending unit sends resource information of the resource to the request source cluster when the resource matched with the dynamic resource information is searched.

### BRIEF DESCRIPTION OF THE DRAWINGS

FIG. 1 is a block diagram of a cluster system according to a first embodiment of the present invention.

FIG. 2 is one example of static resource information used for an embodiment of the present invention.

FIG. 3 is one example of dynamic resource information used for an embodiment of the present invention.

FIG. 4 is a flow chart of a first resource discovery method according to the first embodiment of the present invention.

FIG. 5 is a flow chart of a second resource discovery method according to the first embodiment of the present invention.

FIG. 6 is a flow chart of a third resource discovery method according to the first embodiment of the present invention.

FIG. 7 is a block diagram of a cluster system according to a second embodiment of the present invention.

FIG. 8 is a flow chart of a resource discovery method according to the second embodiment of the present embodiment.

FIG. 9 is a block diagram of a cluster system according to a third embodiment of the present invention.

FIG. 10 is a flow chart of a resource discovery method according to the third embodiment of the present embodiment.

FIG. 11 is a block diagram of the cluster system according to a fourth embodiment of the present invention.

### DETAILED DESCRIPTION OF THE EMBODIMENTS

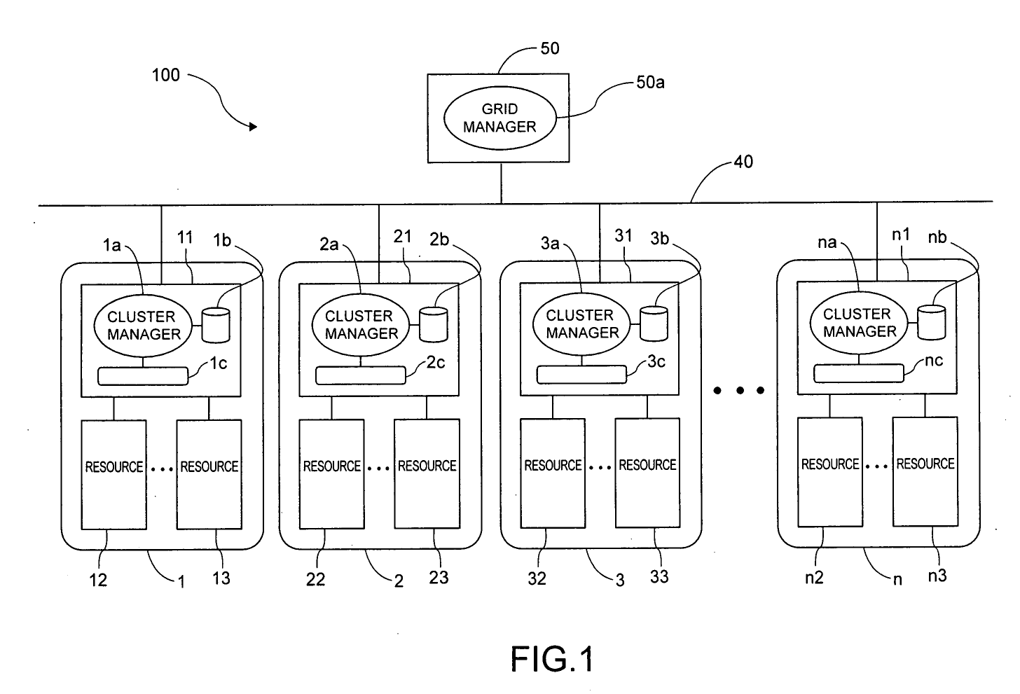

Hereinafter, various embodiments of the present invention will be explained by referring to the drawings. FIG. 1 is a block diagram of the cluster system according to the first embodiment of the present invention. The cluster system of the first embodiment includes a plurality of clusters 1, 2, . . . , n and a computer 50 operating one grid manager 50a to manage the plurality of clusters. The plurality of clusters 1, 2, . . . , n and the computer 50a are connected by a network 40. In the plurality of clusters 1, 2, . . . , n each having the same component, a component of a cluster 1 is mainly explained.

The cluster 1 includes a computer 11 on which a cluster manager 1a runs, and resources 12 and 13 managed by the cluster manager 1a runs, and resources 12 and 13 are respectively computers and each cluster 1, 2, . . . , n respectively includes at least one resource. The cluster manager 1a prepares a static resource information memory 1b to store static resource information related to a resource of its cluster and a dynamic resource information measurement unit 1c to measure dynamic resource information related to the resources of its cluster. In resource accommodation among multiple clusters, these two units are utilized in the case of deciding lendable resources and not utilized in the case of borrowing resources. In an operation example of the first embodiment, the static resource information memory 1b and the dynamic resource measurement unit 1c of the cluster 1 are not used because the cluster 1 borrows resources from other clusters 2, . . . , n. As shown in FIG. 1, the cluster manager 1a may run on a computer different from resources 12 and 13, or may run on computers of the resources 12 or 13. Component of other clusters 2, . . . , n is same as the cluster 1.

In the first embodiment, a group of clusters to mutually accommodate resources is called a grid. In a grid 100 of the first embodiment, a computer 50 including a grid manager 50a is set to mediate resource accommodation among clusters 1, 2, . . . , n. The grid manager 50a is realized as one module of middleware or OS. As shown in FIG. 1, the grid manager 50a may be operated on a computer different from the clusters 1, 2, . . . , n, or may be operated on a computer of the cluster.

The grid manager 50a preserves a pointer to cluster managers 1a, 2a, . . . , na of each cluster 1, 2, . . . , n managed by the grid manager 50a. The grid manager 50a can connect to the cluster managers 1a, 2a, . . . , na using the pointer. By describing the pointer in a set file of the grid manager 50a, a computer 50 of the grid manager 50a may read the pointer at activation timing. Furthermore, when the clusters 1, 2, . . . , n participate in the grid 100, the cluster managers 1a, 2a, . . . , na may send a participation request to the grid manager 50a. As the pointer, in the case of TCP/IP protocol, an IP address and a port number are utilized.

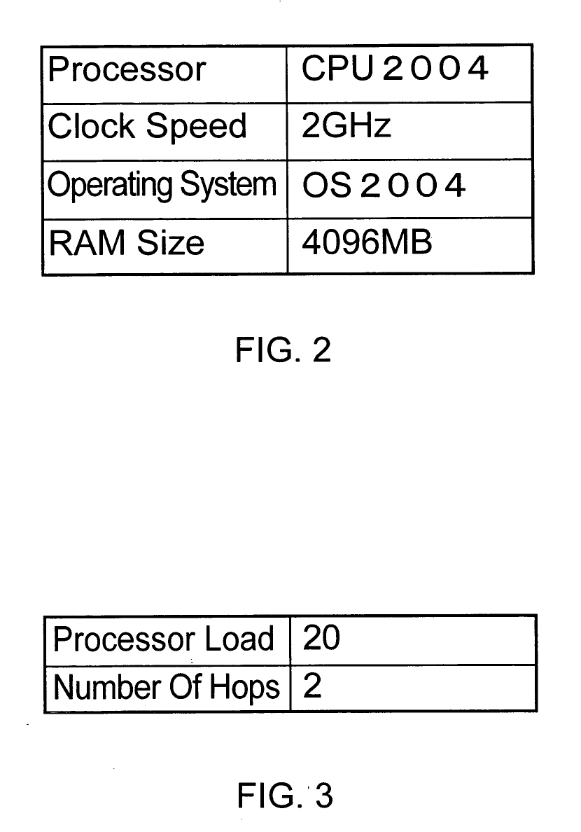

FIG. 2 shows an example of the static resource information stored in the static resource information memory 1b, 2b, . . . , nb. FIG. 3 shows an example of the dynamic resource information measured by the dynamic resource information measurement unit 1c, 2c, . . . , nc. In FIGS. 2 and 3, a left column represents names of resource information and a right column represents corresponding values.

In the static resource information of FIG. 2, a kind of CPU (processor), a clock speed of CPU, a kind of OS, and RAM size are described. FIG. 2 shows a description related to one resource. As for each resource 12, 13, . . . , n2, n3, such static resource information is stored in the static resource information memory 1b, 2b, . . . , nb. The resources 12, 13, . . . , n2, n3 are respectively managed by a unique identifier. The identifiers can be unique only within each cluster. However, in the case of accommodating to another cluster, it is desired that the unique identifier among all clusters is used in order not to change the identifier. For example, in a computer connected by TCP/IP protocol, IP address can be used as the unique identifier among all clusters.

In the dynamic resource information of FIG. 3, a load of a CPU (processor load) and a number of hops to its cluster are described. The dynamic resource information is further explained afterwards.

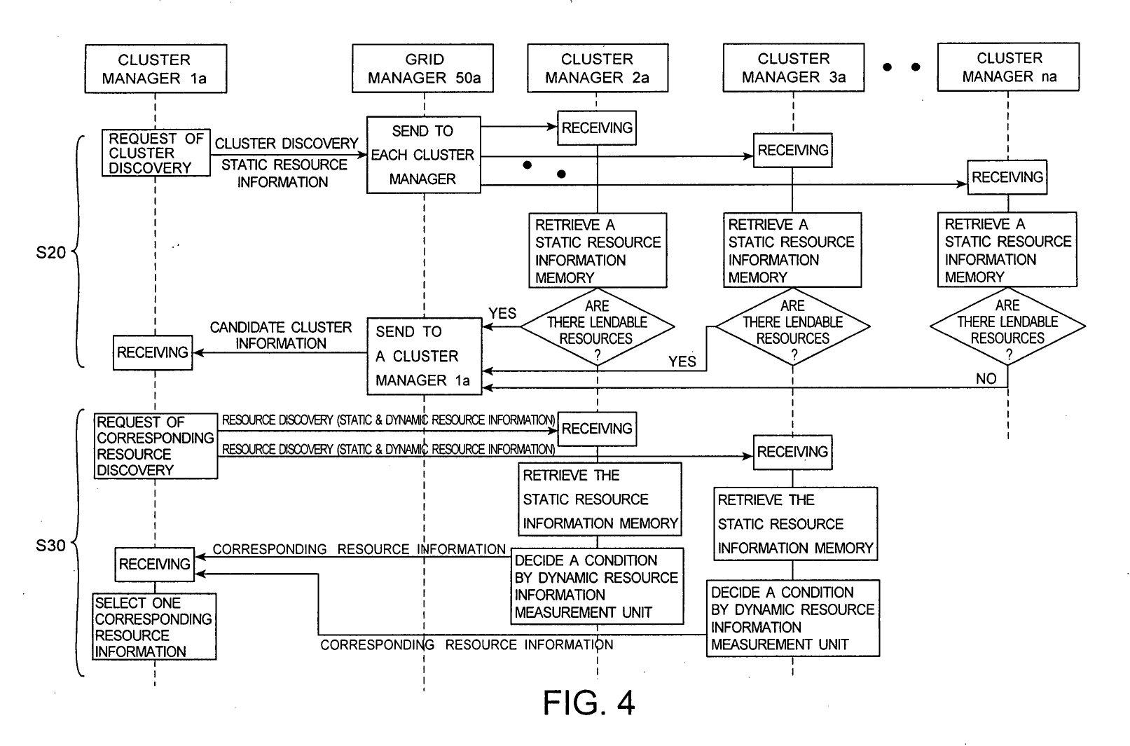

Next, by referring to FIGS. 1-4, a resource discovery method of the first embodiment is explained. FIG. 4 is a flow chart of operation of the first resource discovery method. In FIG. 4, the left most line represents operation of the cluster manager 1a of the cluster 1 to borrow resources from another cluster, and the next line represents operation of the grid manager 50a. A plurality of cluster managers at the right side of the grid manager 50a represents operation of cluster managers 2a, 3a, . . . , na of clusters 2, 3, . . . , n to lend resources to the cluster 1.

In FIG. 4, the resource discovery method includes a candidate cluster discovery step S20 and a corresponding resource discovery step S30. First, the candidate cluster discovery step S20 is explained.

The cluster manager 1a of the cluster 1 issues a cluster discovery request including static resource information to the grid manager 50a. The grid manager 50a transfers the cluster discovery request using the pointer to the cluster managers 2a, 3a, . . . , na of the clusters 2, 3, . . . , n as a resource discovery object in all clusters managed by the grid manager 50a.

In the cluster managers 2a, 3a, . . . , na which received the cluster discovery request, each manager decides whether resources of the self-cluster can be lent by referring to the static resource information memory 2b, 3b, . . . , nb. In this case, if a resource matched with the static resource information of the cluster discovery request is not discovered, the resource to be lent does not exist. Even if a resource matched with the static resource information of the cluster discovery request is discovered, the cluster manager can regard the resource as non-lendable resource because its cluster want to utilize the resource.

As a result of such decision, for example, the cluster managers 2a and 3a of clusters 2 and 3 including lendable resources send candidate cluster information representing that the self-cluster is a candidate cluster to the grid manager 50a, and the cluster managers na of cluster n not including lendable resources sends candidate cluster information representing that the self-cluster is not a candidate cluster to the grid manager 50a. In the present embodiment, by limiting the example to the clusters 2, 3, and n, operation of candidate cluster discovery and corresponding resource discovery are explained. In the case of another cluster, its explanation is omitted in order to simplify the explanation.

Next, after receiving the candidate cluster information from the cluster managers 2a and 3a, the grid manager 50a sends the candidate cluster information to the cluster manager 1a which issued the cluster discovery request.

In the case that a large number of clusters participates in the grid 100 and the cluster manager's cluster is not the candidate cluster, sending of the candidate cluster information may be omitted. In other words, in the case that the cluster manager's own cluster is the candidate cluster, the candidate cluster information is sent. In this method, communication quantity and processing quantity of the candidate cluster information can be reduced.

Furthermore, in FIG. 4, the candidate cluster information is sent to the cluster manager 1a which sent the cluster discovery request through the grid manager 50a. However, the candidate cluster may directly send the candidate cluster information to the cluster manager 1a which issued the cluster discovery request.

Next, the cluster manager 1a waits to receive all candidate cluster information from each cluster manager 2a, 3a, . . . , na. If a number of clusters in the grid 100 is previously known, the cluster manager 1a waits for the candidate cluster information from that number of clusters. However, if a number of clusters in the grid 100 is not known, the candidate cluster information received in a predetermined period may be utilized (a time-out method). Especially, if sending of candidate cluster information is omitted because the cluster manager's cluster is not the candidate cluster, the time-out method is necessary.

Furthermore, waiting may stop at a time when a fixed number of candidate cluster information is received. In this case, the grid manager need not wait for receiving candidate cluster information from all clusters, and need not wait for the passage of a predetermined time.

Furthermore, the grid manager 50a may not individually send each candidate cluster information. After receiving all candidate cluster information, the grid manager 50a may collectively send all candidate cluster information to the cluster manager which issued the cluster discovery request.

The cluster manager 1a which received the candidate cluster information at candidate cluster discovery step S20 enters corresponding resource discovery step S30.

At the beginning of the corresponding resource discovery step S30, the cluster manager 1a sends a resource discovery request to all or a part of the candidate clusters. In FIG. 4, two clusters 2 and 3 are candidate clusters and the resource discovery request is sent to each candidate cluster. However, in general, the resource discovery request is sent to a part of the candidate clusters.

In the case that a resource discovery request is sent to a larger number of candidate clusters in order to discover resources matched with a continuous condition, the resource discovery request is sent to all or a large number of candidate clusters. However, in the case of attaching importance to cost of sending and processing of resource discovery, the resource discovery request is sent to a small number of candidate clusters.

This resource discovery request includes the dynamic resource information in addition to the static resource information. After receiving the resource discovery request, the cluster managers 2a and 3a read the static resource information from the resource discovery request, and retrieves a resource matched with the static resource information from the static resource information memory 2b and 3b of its cluster in the same way as cluster discovery. Furthermore, the cluster managers 2a and 3a read the dynamic resource information from the resource discovery request, and decide whether the retrieved resource satisfies a condition of the dynamic resource information by referring to the dynamic resource information measurement units 2b and 3b of its cluster.

In FIG. 3, processor load represents a dynamic resource that changes over time. For example, by issuing a system call from the dynamic resource information measurement unit 2c to OS, a number of processes or threads executable at the present in scheduler, or an average value of the number within a predetermined period, is read out. The dynamic resource information can be measured based on the read value.

As another dynamic condition in FIG. 3, a number of hops to the cluster (a number of rooters on a path) represents dynamic resource information changed by accommodation to which cluster. For example, by sending ICMP ECHO packet from the cluster manager to the cluster manager 1a which sent the resource discovery request, the network measurement method is realized by the dynamic resource information measurement unit 1c, 2c, nc. The number of hops can be measured based on sending of the packet.

The number of hops to the cluster is dynamic resource information indicated to measure a network distance. As another method to measure the network distance, an unused bandwidth at the present and a response time (round trip time) are adopted. These may be used as the dynamic resource information by measuring the dynamic resource information measurement unit 1c, 2c, . . . , nc.

After receiving the resource discovery request, the cluster managers 2a and 3a discover a resource matched with the condition of the resource discovery request from resources of a self-cluster, and sends static and dynamic resource information of the discovered resource as resource information to the cluster manager 1a.

After receiving the resource information, the cluster manager 1a selects one of corresponding resources. If the condition includes continuous resource information, in general, a resource of the most superior corresponding resource information is selected. However, a resource of corresponding resource information received early may be selected or arbitrary resource may be selected from all corresponding resource information.

As mentioned-above, in the first embodiment, clusters as a discovery object are selected from all clusters, and a resource is discovered from resources of the selected clusters only. Accordingly, communication quantity and processing quantity of resource discovery for resource accommodation between multiple clusters can be reduced.

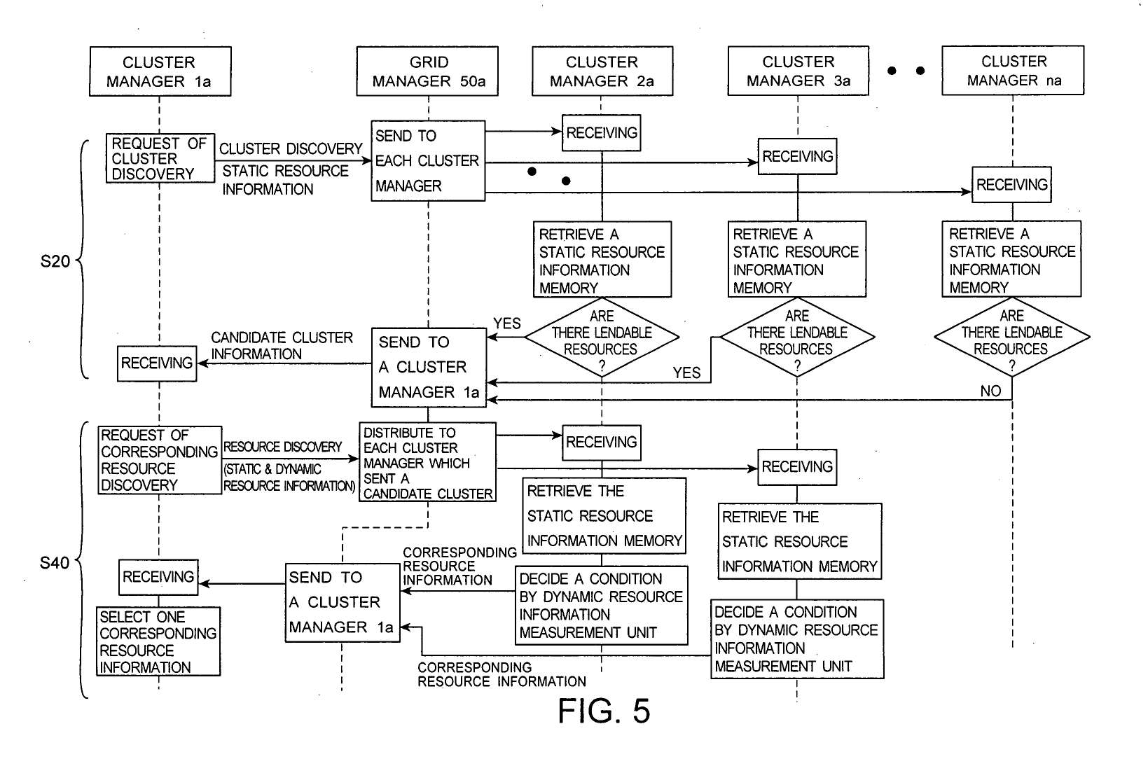

Next, modifications of the resource discovery method of the first embodiment are explained. FIG. 5 is a flow chart of operation of a second resource discovery method. In FIG. 5, a candidate cluster discovery step S20 is the same as the candidate cluster discovery step S20 of FIG. 4.

In the second resource discovery method, a corresponding resource discovery step S40 is different from the corresponding resource discovery step S30. Concretely, in the corresponding resource discovery step S40, the grid manager 50a receives a resource discovery request from the cluster manager 1a, and distributes the resource discovery request to the cluster managers 2a and 3a as candidate clusters. The cluster managers 2a and 3a retrieve a resource matched with a condition of the resource discovery request from resources of their clusters, and send corresponding resource information of the retrieved resource to the grid manager 50a. The grid manager 50a sends the corresponding resource information to the cluster manager 1a.

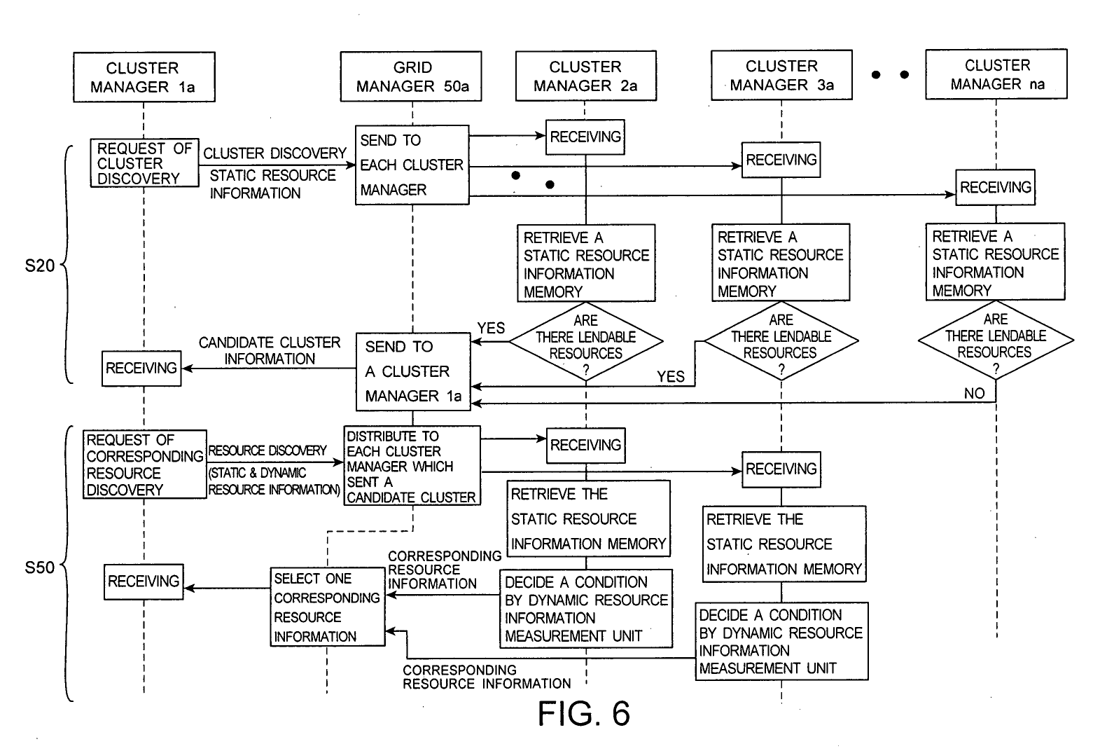

FIG. 6 is a flow chart of operation of a third resource discovery method. In the third resource discovery method, in the same way as the second resource discovery method of FIG. 5, the grid manager 50a executes mediation in a corresponding resource discovery step S50. However, the grid manager 50a participates in determining a cluster from which a resource is accommodated. Briefly, when the grid manager 50a receives corresponding resource information from the cluster managers 2a and 3a, the grid manager 50a selects one from the received corresponding resource information, and sends the selected resource information to the cluster manager 1a. In the above-mentioned second and third resource discovery methods, the same effect as the first resource discovery method of FIG. 4 can be obtained.

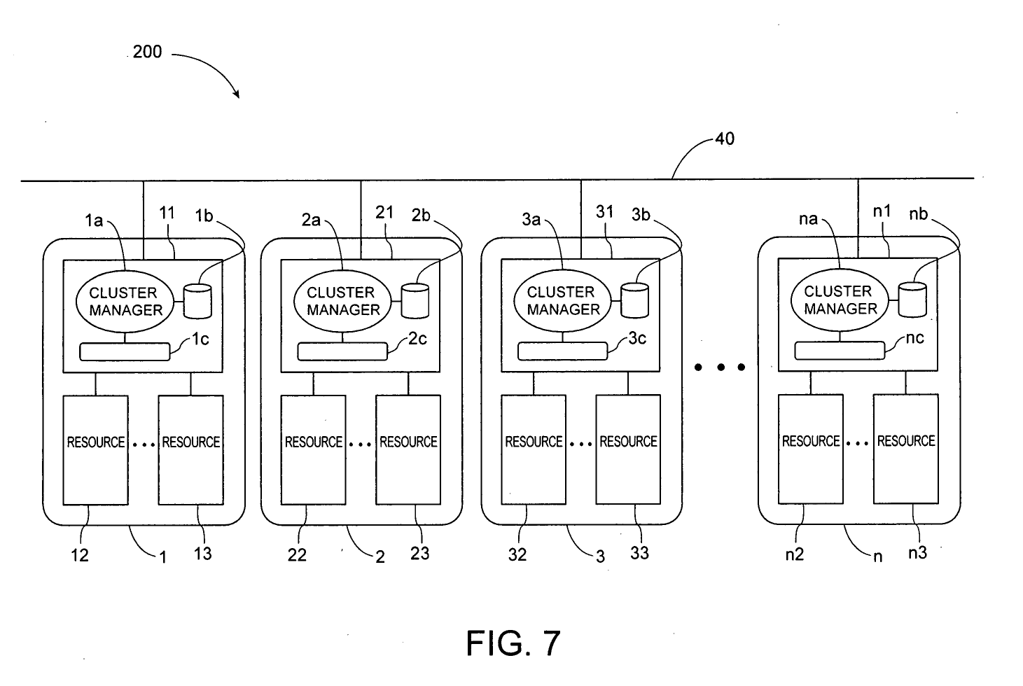

Next, a second embodiment of the present invention is explained. FIG. 7 is a block diagram of a grid 200 of a cluster system according to the second embodiment. All components of FIG. 7 are the same as in FIG. 1 except for non-existence of a grid manager. In the grid including a large number of clusters, if resource discovery is executed through the grid manager 50a in the same way as the first embodiment, load is concentrated to the grid manager 50a and processing ability falls. In the second embodiment, in order to cancel this bottleneck, a grid manager is not set in the grid 200, and resource discovery of peer-to-peer type is executed by connection between cluster managers.

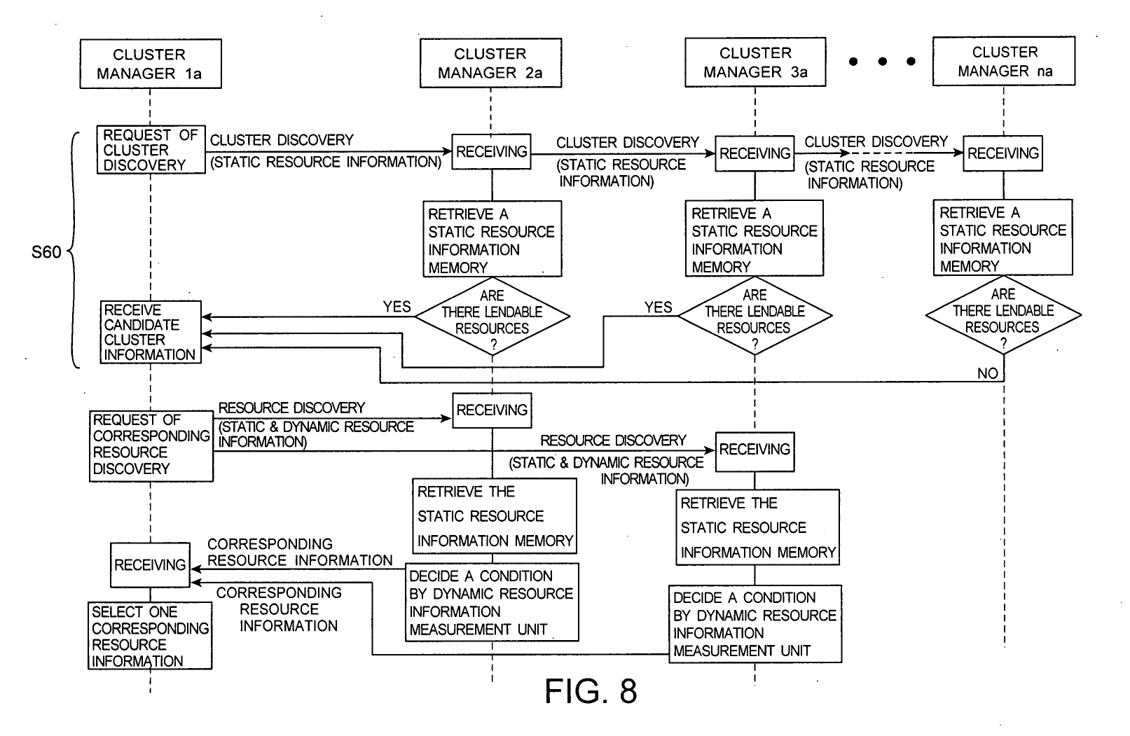

Hereinafter, a resource discovery method of the second embodiment is explained by referring to FIG. 8. FIG. 8 is a flow chart of resource discovery operation of the second embodiment. In FIGS. 7 and 8, the same component elements as in FIG. 1 are assigned the same figure sign.

In a candidate cluster discovery step S60 of FIG. 8, the cluster manager 1a to borrow resources (resource discovery request side) issues a cluster discovery request including static resource information the same as in FIG. 2 to another cluster manager (cluster manager 2a). After receiving the cluster discovery request, the cluster manager 2a transfers the cluster discovery request to a cluster manager 3a, and the cluster manager 3a transfers the cluster discovery request to a cluster manager na. Each cluster manager 2a, 3a, . . . , na retrieves a lendable resource from resources of a self-cluster by referring to each static resource information memory 2b, 3b, . . . , nb, and sends candidate cluster information of the lendable resource to the cluster manager 1a. In the following processing, steps the same as corresponding resource retrieval step S30 are executed, and one of lendable resource information is selected.

As for connection among the cluster managers 1a, 2a, . . . , na in order to transfer the cluster discovery request, technique of peer-to-peer system is utilized. For example, if the cluster manager 1a preserves pointers to other cluster managers 2a, 3a, . . . , na, the cluster manager 1a can issue or transfer the cluster discovery request to other cluster managers 2a, 3a, . . . , na. In order to prevent infinite transfer of cluster discovery request, a method to neglect the same cluster discovery request when the same cluster discovery request is received can be utilized. Furthermore, by assigning an existence period (time to live) to the cluster discovery request, a method to set an upper limit to transfer times of the cluster discovery request can be utilized.

In the second embodiment in the same way as the first embodiment, if a cluster is not a candidate cluster, that cluster may omit sending candidate cluster information. In other words, only if a cluster is a candidate cluster, the cluster sends candidate cluster information. In this case, communication quantity and processing quantity of the candidate cluster information can be reduced.

As mentioned-above, in the second embodiment, in addition to the same effect as the first embodiment, resource discovery can be executed without the grid manager. Accordingly, in the case of the grid including a large number of clusters, falling of processing ability by bottleneck of the grid manager can be reduced.

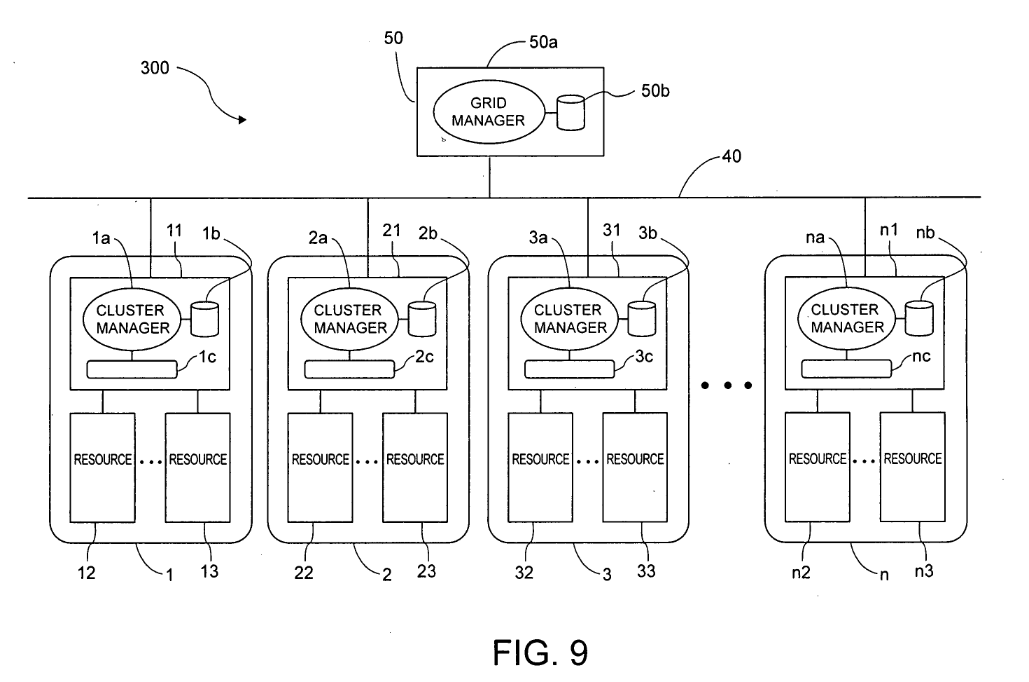

FIG. 9 is a block diagram of a grid 300 of a cluster system according to a third embodiment. In the third embodiment, static resource information of clusters 2, 3, . . . , n is collectively managed, and resource discovery is executed at high speed.

The static resource information is updated in the case that resources are changed such as addition of hardware or replacement of OS. In other words, its update frequency is low and it often happens that resources are not changed for several days/years. Accordingly, by collectively managing static resource information of multiple clusters, an inquiry to each cluster manager can be omitted and resource discovery can be executed at high speed.

In the third embodiment, a multiple clusters-static resource information memory 50b is located in a grid manager 50a and commonly used with the static resource information memory 1b, 2b, . . . nb of clusters 1, 2, . . . , n.

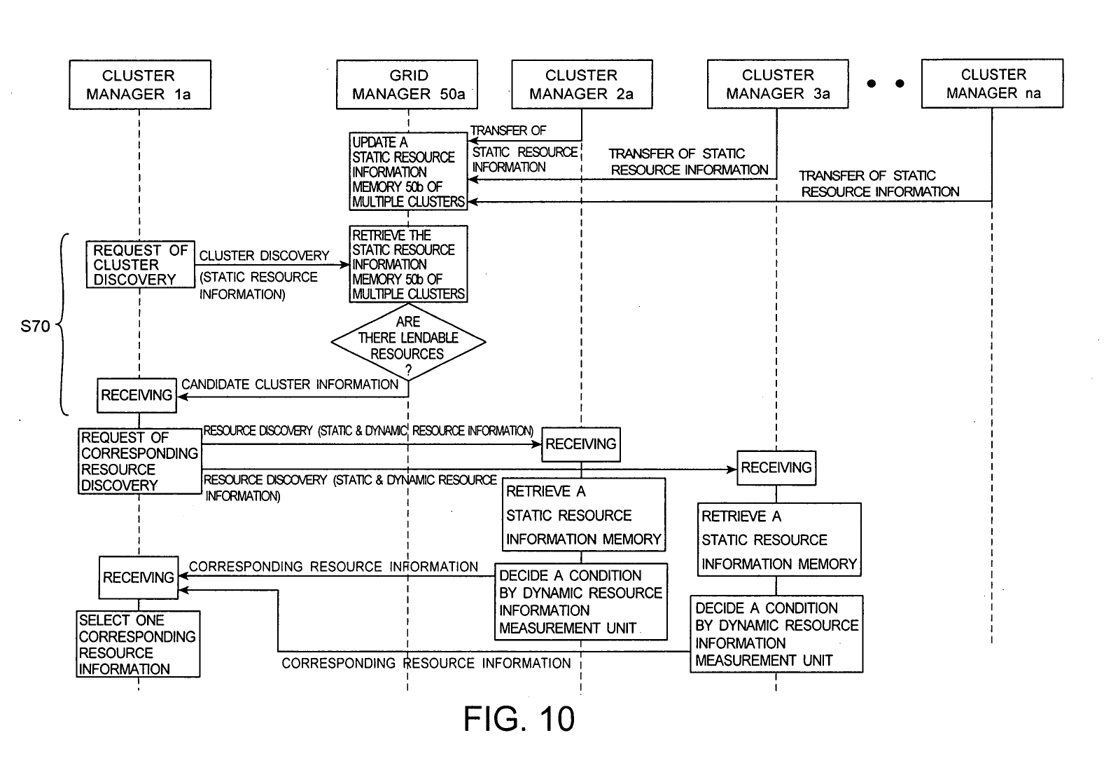

Hereinafter, resource discovery method of the third embodiment is explained by referring to FIG. 10. FIG. 10 is a flow chart of the resource discovery method of the third embodiment. In FIGS. 9 and 10, component elements the same as in FIG. 1 are assigned the same figure sign.

In the third embodiment, the same static resource information is stored in both the static resource information memory 1b, 2b, . . . , nb of clusters 1, 2, . . . , n and the multiple clusters-static resource information memory 50b. Accordingly, in order to maintain consistency of the same information among memories, transfer of the static resource information is necessary. For example, the static resource information is transferred from the static resource information memory 1b, 2b, nb of clusters 1, 2, . . . , n to the multiple clusters-resource information memory 50b of grid manager 50a at a predetermined interval. If an update date is assigned to resource information, by transferring only information updated from previous transfer time, transfer of information not updated can be omitted, and transfer quantity and processing quantity can be reduced.

Furthermore, in the multiple clusters-static resource information memory 50b and the static resource information memory 1b, 2b, nb, another method for storing static resource information may be utilized. Concretely, detail static resource information is stored in the static resource information memory 1b, 2b, . . . , nb, and a summary of the static resource information is stored in the multiple clusters-static resource information memory 50b.

In candidate cluster discovery step S70, after receiving a cluster discovery request from the cluster manager 1a, the grid manager 50a retrieves a lendable resource from the multiple clusters-static resource information memory 50b, and sends candidate cluster information of a cluster including the lendable resource to the cluster manager 1a. A corresponding resource discovery step of FIG. 10 is the same as in FIG. 4. As the corresponding resource discovery step, step S40 of FIG. 5 and step S50 of FIG. 6 may be executed.

As mentioned-above, in the third embodiment, in addition to effect same as the first embodiment, by setting the multiple clusters-static resource information memory to the grid manager, retrieval of static resource to each cluster can be omitted.

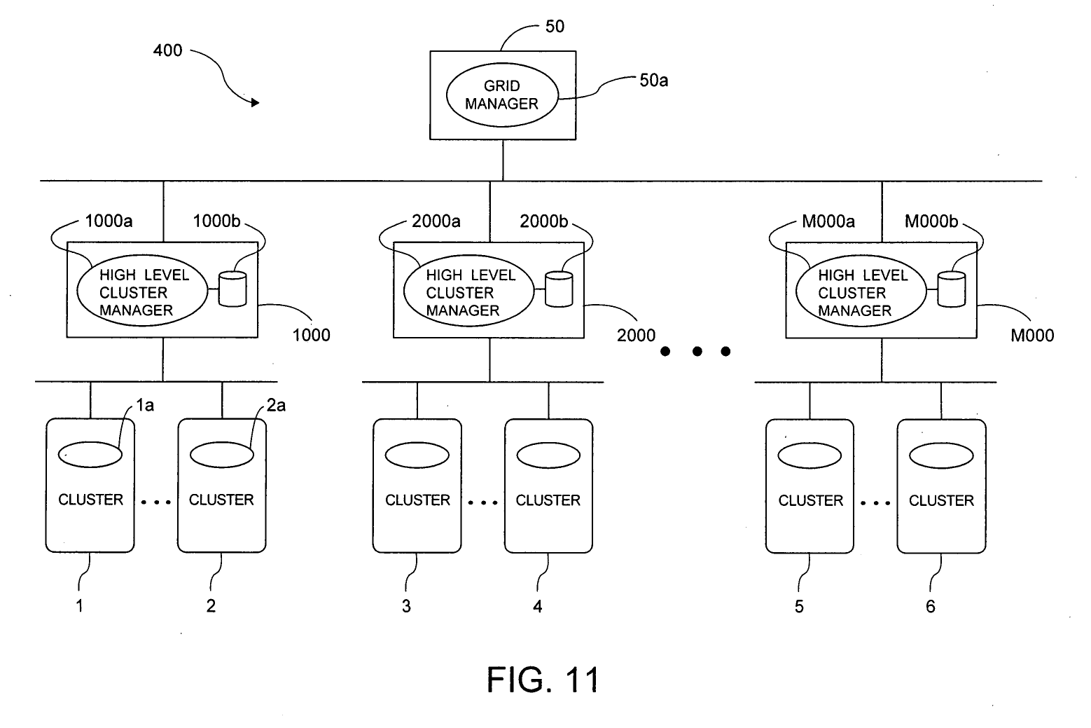

FIG. 11 is a block diagram of a grid 400 of a cluster system according to the fourth embodiment. In the fourth embodiment, for example, a high level cluster manager 1000a is set between the grid manager 50a and cluster managers 1a and 2a. A multiple clusters-static resource information memory 1000b is located with the high level cluster manager 1000a. Other high level cluster managers 2000a and M000a have the same component. The high level cluster managers 1000a, 2000a, . . . , M000a are set in computers 1000, 2000, . . . , M000.

In the third embodiment, as for a large number of clusters, if static resource information of all clusters is periodically transferred to the grid manager 50a and stored in the multiple clusters-static resource information memory 50b, the required processing bottlenecks, and processing ability falls.

In order to cope with this problem, in the fourth embodiment, a high level cluster is set between a grid and a cluster, and high level cluster managers 1000a, 2000a, . . . , M000a are respectively located. In FIG. 11, multiple clusters-static resource information memories 1000b, 2000b, . . . , M000b are respectively located with the high level cluster managers 1000a, 2000a, . . . , M000a. The static resource information of resources of all clusters belonging to each high level cluster is stored in each multiple clusters-static resource information memory. A relationship between the high level cluster manager and the cluster is the same as a relationship between the grid manager and the cluster in the third embodiment.

After receiving a cluster discovery request, the grid manager 50a transfers the cluster discovery request to each high level cluster manager 1000a, 2000a, . . . , M000a. The high level cluster manager 1000a, 2000a, . . . , M000a respectively decides whether each cluster belonging to its high level cluster includes a lendable resource by referring to the multiple clusters-static resource information memory 1000b, 2000b, . . . , M000b. The high level cluster manager 1000a, 2000a, . . . M000a respectively sends a decision result as candidate cluster information to the cluster manager that issued the cluster discovery request.

In the fourth embodiment, in addition to the same effect as in the first embodiment, by hierarchically setting high level clusters, resource discovery can be distributively executed.

As mentioned-above, in the present invention, clusters as a discovery object are selected from all clusters, and a resource is discovered from resources of the selected clusters only. Accordingly, communication quantity and processing quantity of resource discovery for resource accommodation between multiple clusters can be reduced.

For embodiments of the present invention, the processing of the present invention can be accomplished by a computer-executable program, and this program can be realized in a computer-readable memory device.

In embodiments of the present invention, the memory device, such as a magnetic disk, a floppy disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device. The component of the device may be arbitrarily composed.

In embodiments of the present invention, the computer executes each processing stage of the embodiments according to the program stored in the memory device. The computer may be one apparatus such as a personal computer or a system in which a plurality of processing apparatuses are connected through a network. Furthermore, in the present invention, the computer is not limited to a personal computer. Those skilled in the art will appreciate that a computer includes a processing unit in an information processor, a microcomputer, and so on. In short, the equipment and the apparatus that can execute the functions in embodiments of the present invention using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

1. A resource discovery method in a computer system including a plurality of clusters each having at least one resource, comprising:
searching at least one cluster having a resource matched with static resource information of a cluster discovery request by referring to static resource information of resources in each cluster of a discovery object, the at least one cluster being a candidate cluster; and
searching a resource matched with dynamic resource information of a resource discovery request from the candidate cluster by referring to dynamic resource information of resources in the candidate cluster.

2. The resource discovery method according to claim 1, further comprising:
storing static resource information of resources in each cluster; and
measuring dynamic resource information of resources in each cluster at a predetermined interval.

3. The resource discovery method according to claim 1, further comprising:
before searching a resource matched with dynamic resource information of a resource discovery request,
searching the resource matched with static resource information of the resource discovery request from resources of the candidate cluster by referring to the static resource information of the resources in the candidate cluster, the resource matched with the static resource information being a discovery object to be matched with the dynamic resource information.

4. The resource discovery method according to claim 3,
wherein the static resource information includes at least one of a kind of CPU, a clock speed of CPU, a kind of OS, and a size of RAM, and
wherein the dynamic resource information includes at least one of a load of CPU and a number of hops on a network path.

5. The resource discovery method according to claim 3, further comprising:
issuing the cluster discovery request from a request source cluster to the plurality of clusters except for the request source cluster through a grid manager managing the plurality of clusters in the computer system.

6. The resource discovery method according to claim 3, further comprising:
issuing the cluster discovery request from a request source cluster to the plurality of clusters except for the request source cluster through a plurality of high level cluster managers each managing a subset of the plurality of clusters in the computer system.

7. The resource discovery method according to claim 5, further comprising:
issuing the resource discovery request from a request source cluster to the candidate cluster directly or through the grid manager.

8. The resource discovery method according to claim 5, further comprising:
collectively storing static resource information of resources of the plurality of clusters in the grid manager; and
searching the candidate cluster from the plurality of clusters by referring to the static resource information in the grid manager.

9. The resource discovery method according to claim 7, further comprising:
if a plurality of resources matched with the dynamic resource information are searched from the candidate cluster,
selecting one resource from the plurality of resources by the request source cluster or the grid manager.

10. The resource discovery method according to claim 1, further comprising:
serially issuing the cluster discovery request from the request source cluster to each cluster of the discovery object.

11. A cluster manager apparatus, each cluster having at least one resource in a computer system, comprising:
an issue unit configured to issue a cluster discovery request, including static resource information, to a plurality of clusters of a discovery object; and
a receiving unit configured to receive cluster information matched with the static resource information, the cluster information representing at least one candidate cluster in the plurality of clusters;
wherein said issue unit issues a resource discovery request including dynamic resource information to the at least one candidate cluster; and
wherein said receiving unit receives resource information matched with the dynamic resource information from the at least one candidate cluster.

12. The cluster manager apparatus according to claim 11,
wherein said issue unit issues the cluster discovery request to the plurality of clusters except for said issue unit's cluster through a grid manager apparatus managing the plurality of clusters in the computer system.

13. The cluster manager apparatus according to claim 11,
wherein said issue unit issues the cluster discovery request to the plurality of clusters except for said issue unit's cluster through a plurality of high level cluster manager apparatuses each managing a subset of the plurality of clusters in the computer system.

14. The cluster manager apparatus according to claim 12,
wherein said issue unit issues the resource discovery request to the candidate cluster through the grid manager apparatus.

15. The cluster manager apparatus according to claim 11,
wherein said issue unit serially issues the cluster discovery request to each cluster of the discovery object.

16. A cluster manager apparatus, each cluster having at least one resource in a computer system, comprising:
a static resource information memory configured to store static resource information of resources in a cluster;
a dynamic resource information measurement unit configured to measure dynamic resource information of the resources in the cluster at a predetermined interval;
a search unit configured to search a resource matched with static resource information of a cluster discovery request by referring to said static resource information memory in response to the cluster discovery request sent by a request source cluster; and
a sending unit configured to send cluster information of the cluster to the request source cluster when the resource matched with the static resource information is searched;
wherein said search unit searches a resource matched with dynamic resource information of a resource discovery request by referring to said dynamic resource information measurement unit in response to the resource discovery request sent by the request source cluster, and
wherein said sending unit sends resource information of the resource to the request source cluster when the resource matched with the dynamic resource information is searched.

17. The cluster manager apparatus according to claim 16, wherein,
before said search unit searches the resource matched with the dynamic resource information of the resource discovery request,
said search unit searches a resource matched with the static resource information of the resource discovery request from resources of the cluster by referring to the static resource-information of the resources in the cluster, the resource matched with the static resource information of the resource discovery request being a discovery object to be matched with the dynamic resource information.

18. The cluster manager apparatus according to claim 16,
wherein said sending unit periodically sends static resource information of resources of the cluster to a grid manager apparatus managing the plurality of clusters in the computer system.

19. The cluster manager apparatus according to claim 16,
wherein said sending unit periodically sends static resource information of resources of the cluster to a high level cluster manager apparatus managing a subset of the plurality of clusters, the subset including the cluster.

20. The cluster manager apparatus according to claim 18,
wherein said sending unit sends resource information of the resource matched with the dynamic resource information to the request source cluster through the grid manager apparatus.
